(19) United States
(12) Patent Application Publication
(10) Pub. No.: US 2008/0303307 A1
(43) Pub. Date: Dec. 11, 2008

(54) VEHICLE DOOR MOUNTING

(75) Inventor: Mark A. Savoy, Beverly Hills, MI (US)

Correspondence Address: BROOKS KUSHMAN P.C., 1000 TOWN CENTER, TWENTY-SECOND FLOOR, SOUTHFIELD, MI, 48075, US

(73) Assignee: UTICA ENTERPRISES, INC., Shelby Township, MI (US)

(21) Appl. No.: 12/132,840

(22) Filed: Jun. 4, 2008

Related U.S. Application Data
(60) Provisional application No. 60/933,595, filed on Jun. 7, 2007.

(51) Int. Cl. B60J 5/00

(52) U.S. Cl. 296/146.11; 901/27

(57) ABSTRACT

A method and assembly line (10) for vehicle door mounting provides initial door installation for painting and subsequent reinstallation as previously positioned.

### CROSS-REFERENCE TO RELATED APPLICATIONS

This application claims the benefit of U.S. provisional application Ser. No. 60/933,595 filed on Jun. 7, 2007, the entire disclosure of which is hereby incorporated by reference.

### BACKGROUND OF THE INVENTION

1. Field of the Invention

This invention relates to a method and apparatus for vehicle door mounting.

2. Background Art

Vehicle door mounting preferably provides uniform gap spacing between the vehicle door and adjacent vehicle upper, lower, forward and rearward vehicle body door opening locations as well as with adjacent doors when the vehicle is of the four door type. Also, it is important that vehicle doors have flushness with respect to the adjacent vehicle and/or door surfaces. Such mounting is further complicated by the fact that it is conventional to initially mount each vehicle door on the vehicle body for rust preventative coating and painting prior to door removal and installation in both the vehicle body and the door of associated vehicle body and door components, respectively, which cannot pass through the painting.

Proper door mounting must account for tolerances in the vehicle body formed sheet metal parts and assembly and in the door sheet metal parts and assembly. Usually differences in the tolerances are the same for any production run of formed sheet metal parts and assembly since the associated tooling involved will normally produce uniform sizes and shapes for any production run.

### SUMMARY OF THE INVENTION

An object of the present invention is to provide an improved method for vehicle door mounting.

In carrying out the above object, the method for mounting a vehicle door on a vehicle body in accordance with the invention is preformed with lower and upper door hinges each of which has body and door hinge members pivotally connected to each other. A door opening of the vehicle body is gauged to determine horizontal longitudinal X, horizontal lateral Y and vertical Z positioning required to provide door to vehicle body horizontal and vertical gap spacing and to provide door to vehicle body flushness. The body hinge members of the hinges are mounted on the vehicle body in accordance with the door opening gauge positioning to provide one of either horizontal longitudinal X door to vehicle body gap spacing positioning or horizontal lateral Y door to vehicle body flushness positioning and to also provide vertical Z door to vehicle body gap spacing positioning. A door is then mounted on the hinges at the door hinge members each of which has a pair of connection openings, with one connection opening of the door hinge member of one of the hinges providing the other of either horizontal longitudinal X door to vehicle body gap spacing positioning or horizontal lateral Y door to vehicle body flushness positioning and also providing vertical Z door to vehicle body gap spacing positioning, and with another connection opening of the door hinge member of the other hinge also providing the other of either horizontal longitudinal X door to vehicle body gap spacing positioning or horizontal lateral Y door to vehicle body flushness positioning but having vertical Z tolerance. The vehicle body is then painted with the door mounted thereon, and the door is thereafter removed from the hinges at the door hinge members thereof with the hinges remaining mounted on the vehicle body. Vehicle body components are installed on the painted vehicle body and door components are installed on the removed door. Thereafter, the door is remounted on the hinges at the door hinge members thereof with the previous positioning providing horizontal and vertical door to vehicle body gap spacing and lateral flushness.

In one mode of the vehicle door mounting method, the vehicle body hinge members of the hinges are mounted on a longitudinally and vertically extending vehicle body surface so the mounting thereof provides horizontal longitudinal X door to vehicle body gap spacing positioning and vertical Z door to vehicle body gap spacing positioning, and the door hinge members of the hinges are mounted on a door surface that in the door closed position extends laterally and vertically so the one connection opening of the door hinge member of one of the hinges provides horizontal longitudinal X door to vehicle body gap spacing positioning and vertical Z door to vehicle body gap space positioning and so the mentioned connection opening of the door hinge member of the other hinge provides horizontal lateral Y flushness positioning with vertical Z tolerance.

In another mode of the vehicle door mounting method, the vehicle body hinge members of the hinges are mounted on a laterally and vertically extending vehicle body surface so the mounting thereof provides horizontal lateral Y flushness positioning and vertical Z door to vehicle body gap spacing positioning, and the door hinge members of the hinges are mounted on a door surface that in the door closed position extends longitudinally and vertically so the one connection opening of the door hinge member of one of the hinges provides horizontal longitudinal X door to vehicle body gap spacing positioning and vertical Z door to vehicle body gap space positioning and so the mentioned connection opening of the door hinge member of the other hinge provides horizontal longitudinal X door to vehicle body gap positioning with vertical Z tolerance.

The vehicle door mounting method as disclosed is performed on a vehicle body having front and rear door openings one of which is associated with the recited first door and the other of which is associated with a second door. The gauging is performed to determine door to vehicle body gap spacing and door to door gap spacing, and the second door is: mounted on the vehicle body by a second pair of lower and upper hinges that are mounted on the vehicle body and that mount the second door in the same manner the first door is mounted by the associated hinges, painted with the vehicle body and the first door, removed for mounting of door components, and remounted on the vehicle body in the same manner as the first door.

The vehicle door mounting method as disclosed is performed with the door hinge member of the lower hinge including lower and upper connection openings with its lower connection opening providing one of either the vertical and horizontal positioning or just horizontal positioning, and with the door hinge member of the upper hinge including lower and upper connection openings with its upper connection opening providing the other of either the vertical and horizontal positioning or just horizontal positioning. The upper connection opening of the door hinge member of the lower hinge utilized and the lower connection opening of the door hinge member of the upper hinge utilized are oversized to permit horizontal and vertical tolerance in mounting of the door.

In performing the vehicle door mounting method as disclosed, the door is gauged and the one connection opening of the door hinge member of the one hinge is formed in response to this gauging to provide proper horizontal door positioning with respect to the vehicle body.

Another aspect of the present invention is to provide an improved assembly line for vehicle door mounting.

In carrying out the immediately preceding object, the improved door mounting assembly line mounts a vehicle door on a vehicle body by lower and upper door hinges each of which has body and door hinge members pivotally connected to each other. Apparatus of the assembly line gauges a door opening of the vehicle body to determine longitudinal and vertical positioning required to provide door to vehicle body gap spacing and door to vehicle body flushness. A robot mounts the body hinge members of the hinges on the vehicle body in accordance with the door opening gauge positioning. A robot also mounts a door on the hinges at the door hinge members each of which has a pair of connection openings, with one connection opening of the door hinge member of one of the hinges providing vertical positioning of the door with respect to the vehicle body and also providing one of either longitudinal or lateral horizontal positioning of the door with respect to the vehicle body, and with another connection opening of the door hinge member of the other associated hinge providing the other of either longitudinal or lateral horizontal positioning of the door with respect to the vehicle body while having vertical tolerance.

A paint station of the assembly paints the vehicle body and the door mounted thereon, and at least one further station: removes the painted door from the hinges at the door hinge members thereof with the hinges remaining mounted on the vehicle body, then installs vehicle body components on the painted vehicle body and installs door components on the removed door, and thereafter remounts the door on the hinges at the door hinge members thereof with the previous positioning providing door to vehicle body gap spacing.

The assembly line for mounting a vehicle door as disclosed includes a vehicle body conveying branch along which the painted vehicle body is conveyed for installation of the vehicle body components, and a door conveying branch along which the painted door is conveyed for installation of the door components. The disclosed assembly line also includes a hinge piercing station for forming the connection openings in the door hinge members of the hinges. Furthermore, a door gauge determines the proper location of the one connection opening of the door hinge member of the one hinge providing vertical and horizontal positioning of the door, and the door gauge also determines the proper location of the connection opening of the door hinge member of the other hinge providing horizontal positioning of the door. As disclosed, the vehicle body gauging station gauges front and rear door openings and includes robots for mounting front and rear sets of upper and lower hinges on the vehicle body and for respectively mounting the front and rear doors on the hinges with door to provide vehicle body gap spacing, door to door gap spacing and door to vehicle body flushness prior to painting and for subsequent door removal for the vehicle body and door component installation and subsequent remounting of the front and rear doors.

### BRIEF DESCRIPTION OF THE DRAWINGS

FIG. 1 is a schematic view illustrating a vehicle door mounting assembly line constructed in accordance with the present invention.

FIG. 2 is a schematic top plan view that illustrates the use of robots at the various stations of the door mounting assembly line.

FIGS. 3 and 4 are respectively side and top plan views of a vehicle body illustrating one arrangement of gauge points utilized to provide vehicle geometry during the door mounting.

FIGS. 5 and 6 are respectively side and top plan views of a vehicle body illustrating another arrangement of gauge points utilized to provide vehicle body geometry during door mounting.

FIGS. 7 and 8 are respectively a rearwardly looking view of a right hand door and a sideways looking view of the right hand vehicle body at the forward location of the door opening, such that the vehicle hinges are mounted on the vehicle body in a horizontal longitudinal X and vertical Z plane and such that the hinges are mounted on the door in a horizontal lateral Y and vertical Z plane.

FIGS. 9 and 10 are views respectively similar to FIGS. 7 and 8 but respectively showing the right hand door viewed looking outwardly in a lateral direction and showing the right hand vehicle body looking forwardly in a longitudinal direction, such that the hinges are mounted on the vehicle body in a horizontal lateral Y and vertical Z plane and such that the hinges are mounted on the door in a horizontal longitudinal X and vertical Z plane.

FIG. 11 illustrates a hinge piercing tool for properly locating hinge door member holes in accordance with vehicle body and door gauging data.

### DETAILED DESCRIPTION OF THE PREFERRED EMBODIMENTS

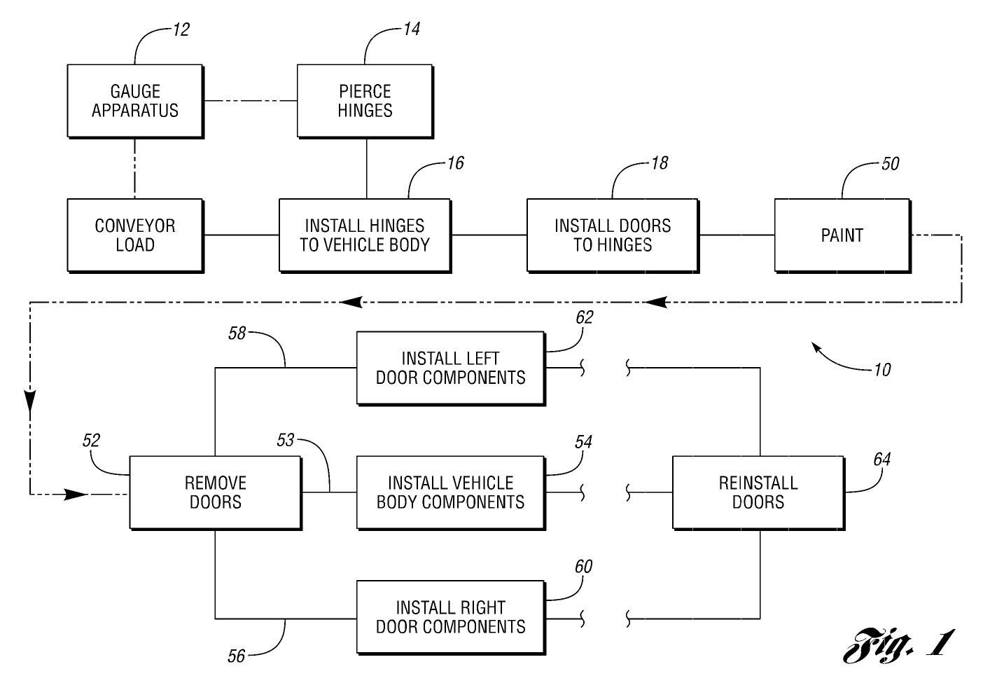

FIG. 1 schematically illustrates a vehicle body assembly line 10 for providing door mounting in accordance with the invention. Both the assembly line 10 and the door mounting method of the invention will be described in an integrated manner to facilitate an understanding of all aspects of the invention.

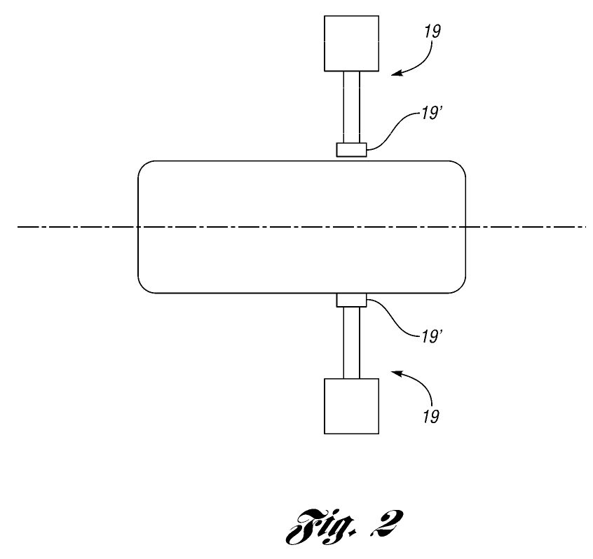

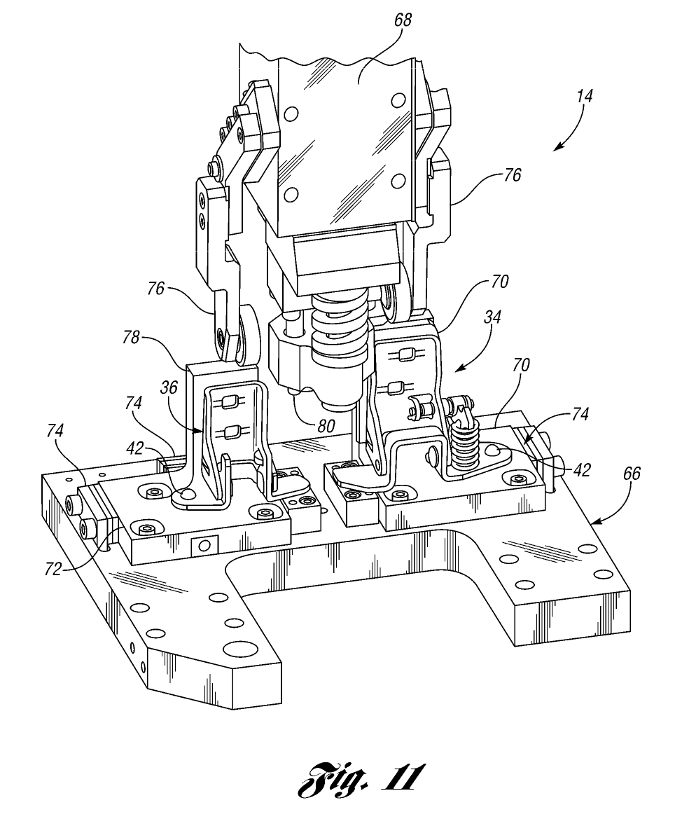

Gauge apparatus 12 of any conventional type is shown in FIG. 1 and utilized to provide gauge data of the vehicle body door opening so that the gauge data can be utilized to provide the door installation with uniform gap spacing and flushness. More specifically, this gauge data is utilized by piercing apparatus 14 also shown in FIG. 11 to provide the proper location of hinge to door positioning holes which are assembled after the hinge to vehicle body assembly 16 using robots. The door to hinge assembly is identified in FIG. 1 at 18. The vehicle body gauging will normally be performed on one, two, or however many parts of a production run as needed, to establish the proper gauge data needed to perform the door mounting. Thus, not every vehicle body and door is itself actually gauged, since the gauging of a limited number of vehicle bodies and doors from the same production runs is effectively gauging of each one. Also, the installation steps as well as removal steps hereinafter described are performed using robots 19 which, as shown in FIG. 2, have suitable end effectors 19′ for performing the applicable task.

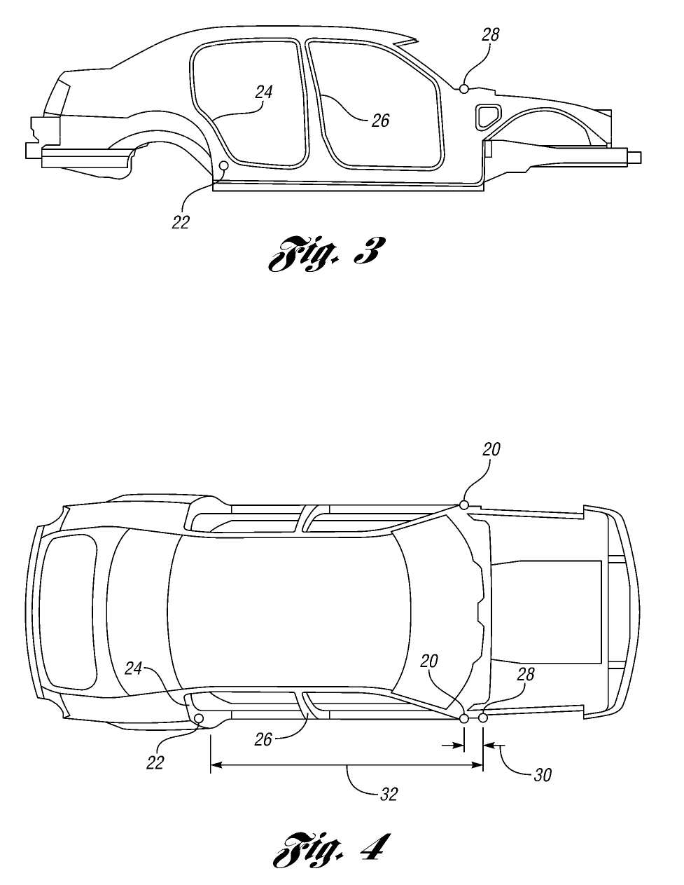

With reference to FIGS. 3 and 4, one way of assembling to provide uniform spacing of both door to vehicle body and door to door utilizes a master gauge hole 20 at a front pillar location and lower rear gauge points 22 in the rear pillar 24 behind the middle pillar 26. A gauge point 28 at the location of the rear extremity of the vehicle fender is sensed to provide the appropriate spacing 30 with respect to the master gauge hole 20 so as to provide a total spacing 32 for use in providing uniform gap spacing in the door mounting. At the location of mounting, the vehicle metal will be formed to the proper location and then pierced to provide the hinge mounting. As such, the distance between the rear extremity of the fender and the gauge holes may be unique from right to left and may vary from one vehicle body to the next. As such, accommodation may have to be made to provide the uniform gap spacing.

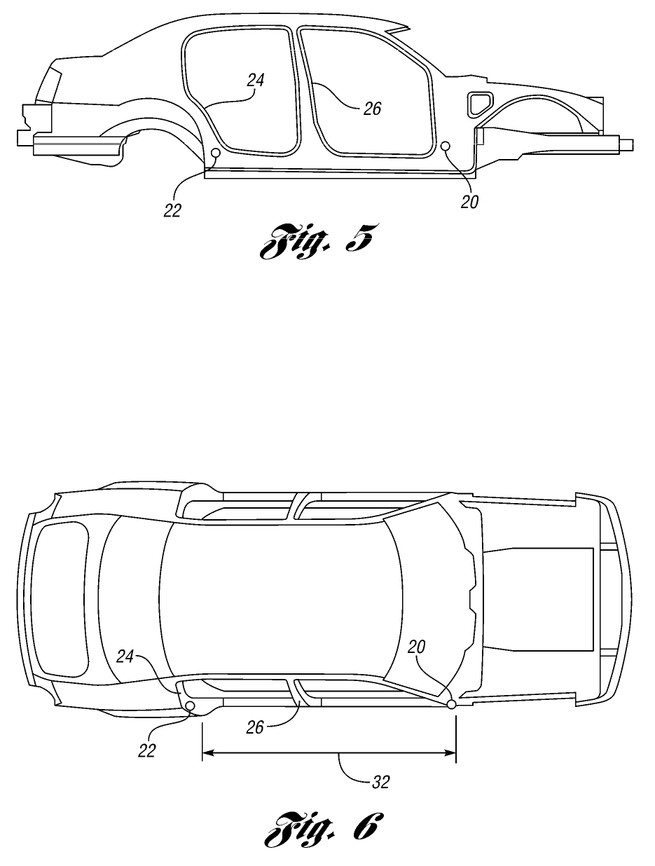

With reference to FIGS. 5 and 6, in another practice of the gauging, the overall spacing 32 is calculated between the front master gauge hole 20 that functions as a gauge point and a rear gauge hole 22.

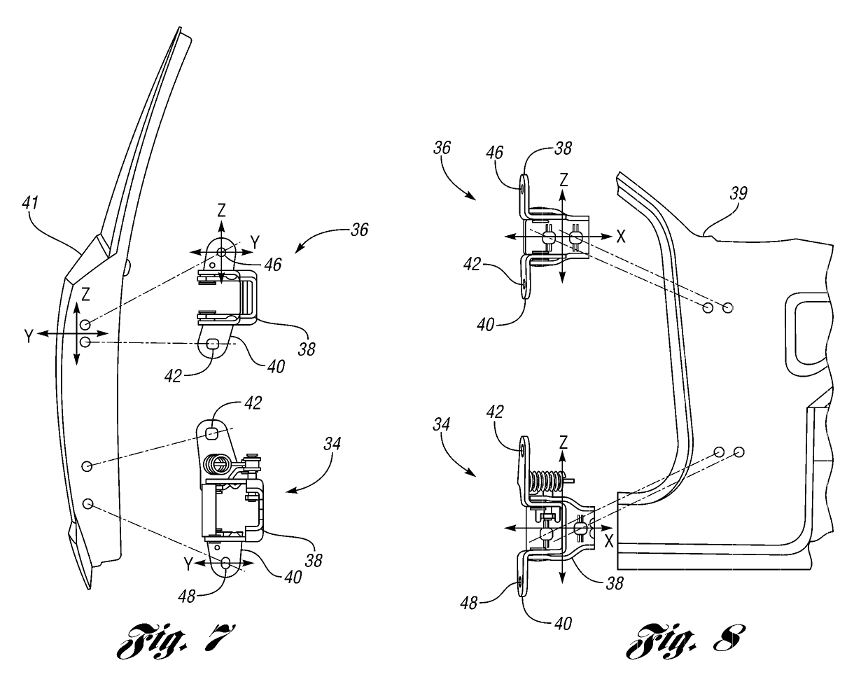

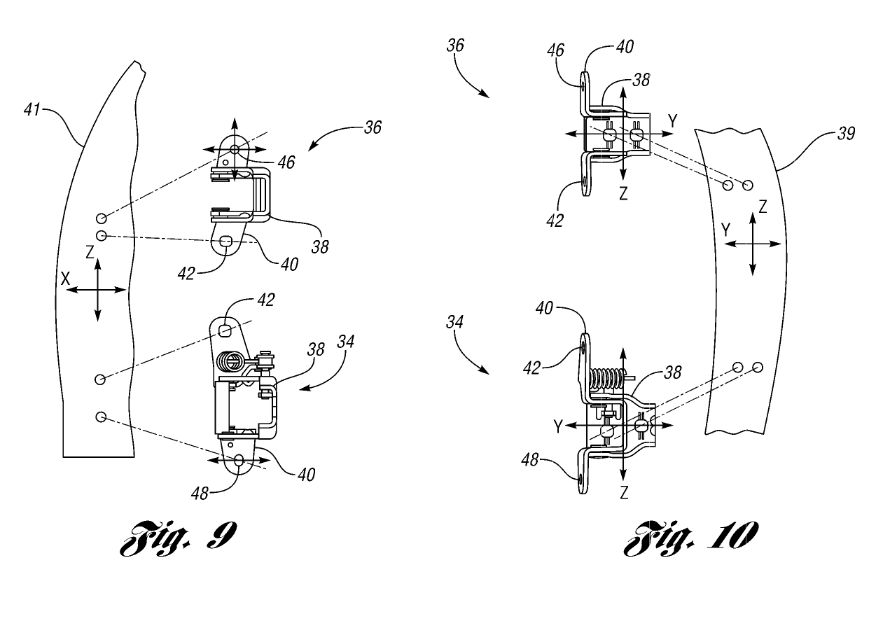

With reference to FIGS. 7 and 8 and also to FIGS. 9 and 10, lower and upper hinges 34 and 36 each have pivotally connected vehicle body and door hinge members 38 and 40, respectively. The body hinge members 38 are mounted on the vehicle body 39 and the door hinge members mount the associated door 41. Each vehicle body hinge member 38 has oversized holes 42 to permit mounting on the vehicle body at the proper location either in a horizontal longitudinal X and vertical Z plane as shown in FIGS. 7 and 8 or in a horizontal lateral Y and vertical Z plane as shown in FIGS. 9 and 10. Each of the door hinge members 40 also has one oversize hole 42. Furthermore, one of the hinges, the upper hinge 22 as shown, has its door hinge member 40 provided with a four-way positioning hole 46 that provides positioning in two directions, the horizontal lateral Y and vertical Z directions in FIGS. 7 and 8 and the horizontal longitudinal X and vertical Z directions in FIGS. 9 and 10. Furthermore, the hinge member 40 of the other hinge has a two-way positioning hole 48 for providing positioning in the horizontal lateral Y direction in FIGS. 7 and 8 and the horizontal longitudinal X direction in FIGS. 9 and 10 with respect to the associated doors. It should be noted that the positioning holes 46 and 48 are preferably spaced at the extreme locations from each other with the oversize holes 42 located therebetween so as to provide the maximum lever arm for supporting the door. It should also be noted that after installation of the door components as is hereinafter described, the distal end of the door remote from the hinges can sag downwardly due to the component weight such that that sag factor can be compensated for by the positioning utilized during the initial door mounting.

With reference back to FIG. 1, after the door installation, the vehicle goes through a paint coating station 50 which may also include an initial rust preventative coating before the painting to whichever color is utilized.

With continuing reference to FIG. 1, after the painting, the vehicle body goes through a door removal operation 52 where the doors are removed from the hinges while the hinges are maintained assembled to the vehicle body, and the vehicle body then continues along an assembly line 53 for vehicle body component installation as shown at 54 while the right and left doors continue along door assembly lines 56 and 58, respectively, for installation of right and left door components as illustrated at 60 and 62. After installation of the vehicle body and door components, the doors are reinstalled to the hinges on the vehicle body as illustrated at 64 with the door positioning holes 46 and 48 providing the same position as the initial installation.

With reference to FIG. 11, the hinge piercing apparatus 14 includes a base 66 and a ram 68 supported on the base. Hinge nests 70 and 72 for respectively supporting the lower and upper hinges 20 and 22 are positioned by adjusters 74 to provide proper location of the hinges which are pined through their oversized holes 42 for positioning. Roller arms 76 on the ram 68 clamp the body hinge member of each hinge to an upward projection 78 of the associated nest 70 or 72 during the piercing operation. Punches 80 perform the piercing to provide the four-way positioning hole and two-way positioning hole previously described.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for mounting a vehicle door on a vehicle body by lower and upper door hinges each of which has body and door hinge members pivotally connected to each other, comprising:
gauging a door opening of the vehicle body to determine horizontal longitudinal X, horizontal lateral Y and vertical Z positioning required to provide door to vehicle body horizontal and vertical gap spacing and to provide door to vehicle body flushness;
mounting the body hinge members of the hinges on the vehicle body in accordance with the door opening gauge positioning to provide one of either horizontal longitudinal X door to vehicle body gap spacing positioning or horizontal lateral Y door to vehicle body flushness positioning and to also provide vertical Z door to vehicle body gap spacing positioning;
mounting a door on the hinges at the door hinge members each of which has a pair of connection openings, with one connection opening of the door hinge member of one of the hinges providing the other of either horizontal longitudinal X door to vehicle body gap spacing positioning or horizontal lateral Y door to vehicle body flushness positioning and also providing vertical Z door to vehicle body gap spacing positioning, and with another connection opening of the door hinge member of the other hinge also providing the other of either horizontal longitudinal X door to vehicle body gap spacing positioning or horizontal lateral Y door to vehicle body flushness positioning but having vertical Z tolerance;
then painting the vehicle body and the door mounted thereon;
thereafter removing the door from the hinges at the door hinge members thereof with the hinges remaining mounted on the vehicle body;
then installing vehicle body components on the painted vehicle body and door components on the removed door; and
thereafter remounting the door on the hinges at the door hinge members thereof with the previous positioning providing horizontal and vertical door to vehicle body gap spacing and lateral flushness.

2. A vehicle door mounting method as in claim 1 wherein the vehicle body hinge members of the hinges are mounted on a longitudinally and vertically extending vehicle body surface so the mounting thereof provides horizontal longitudinal X door to vehicle body gap spacing positioning and vertical Z door to vehicle body gap spacing positioning, and the door hinge members of the hinges being mounted on a door surface that in the door closed position extends laterally and vertically so the one connection opening of the door hinge member of one of the hinges provides horizontal longitudinal X door to vehicle body gap spacing positioning and vertical Z door to vehicle body gap space positioning and so the mentioned connection opening of the door hinge member of the other hinge provides horizontal lateral Y flushness positioning with vertical Z tolerance.

3. A vehicle door mounting method as in claim 1 wherein the vehicle body hinge members of the hinges are mounted on a laterally and vertically extending vehicle body surface so the mounting thereof provides horizontal lateral Y flushness positioning and vertical Z door to vehicle body gap spacing positioning, and the door hinge members of the hinges being mounted on a door surface that in the door closed position extends longitudinally and vertically so the one connection opening of the door hinge member of one of the hinges provides horizontal longitudinal X door to vehicle body gap spacing positioning and vertical Z door to vehicle body gap space positioning and so the mentioned connection opening of the door hinge member of the other hinge provides horizontal longitudinal X door to vehicle body gap positioning with vertical Z tolerance.

4. A vehicle door mounting method as in claim 1 wherein the vehicle body has front and rear door openings one of which is associated with the recited first door and the other of which is associated with a second door; the gauging being performed to determine door to vehicle body gap spacing and door to door gap spacing; and the second door being: mounted on the vehicle body by a second pair of lower and upper hinges that are mounted on the vehicle body and that mount the second door in the same manner the first door is mounted by the associated hinges, painted with the vehicle body and the first door, removed for mounting of door components, and remounted on the vehicle body in the same manner as the first door.

5. A vehicle door mounting method as in claim 1 wherein the door hinge member of the lower hinge includes lower and upper connection openings with its lower connection opening providing one of either the vertical and horizontal positioning or just horizontal positioning, and the door hinge member of the upper hinge including lower and upper connection openings with its upper connection opening providing the other of either the vertical and horizontal positioning or just horizontal positioning.

6. A vehicle door mounting method as in claim 5 wherein the upper connection opening of the door hinge member of the lower hinge and the lower connection opening of the door hinge member of the upper hinge are oversized to permit horizontal and vertical tolerance in mounting of the door.

7. A vehicle door mounting method as in claim 1 wherein the door is gauged and said one connection opening of the door hinge member of the one hinge is formed in response to this gauging to provide proper horizontal door positioning with respect to the vehicle body.

8. A method for mounting left and right sets of front and rear vehicle doors on a vehicle body by associated sets of lower and upper door hinges each of which has body and door hinge members pivotally connected to each other, comprising:
gauging adjacent left and right front and rear door openings of the vehicle body to determine longitudinal and vertical positioning required to provide door to vehicle body gap spacing, door to door gap spacing and to determine horizontal positioning required to provide door to vehicle body flushness;
mounting the body hinge members of each hinge on the vehicle body in accordance with the door opening gauge positioning;
mounting the front and rear doors on the associated hinges at the door hinge members each of which has a pair of connection openings, with one connection opening of the door hinge member of one of the associated hinges providing vertical positioning of the door with respect to the vehicle body and also providing one of either longitudinal or lateral horizontal positioning of the door with respect to the vehicle body, and with another connection opening of the door hinge member of the other associated hinge providing the other of either longitudinal or lateral horizontal positioning of the door with respect to the vehicle body while having vertical tolerance;
then painting the vehicle body and the doors mounted thereon;
thereafter removing the doors from the hinges at the door hinge members thereof with the hinges remaining mounted on the vehicle body;
then installing vehicle body components on the painted vehicle body and installing door components on the removed doors; and
thereafter remounting the doors on the hinges at the door hinge members thereof with the previous positioning providing door to vehicle body gap spacing, door to door gap spacing and door to vehicle body flushness.

9. An assembly line for mounting a vehicle door on a vehicle body by lower and upper door hinges each of which has body and door hinge members pivotally connected to each other, comprising:
apparatus for gauging a door opening of the vehicle body to determine longitudinal and vertical positioning required to provide door to vehicle body gap spacing and door to vehicle body flushness;
a robot for mounting the body hinge members of the hinges on the vehicle body in accordance with the door opening gauge positioning;
a robot for mounting a door on the hinges at the door hinge members each of which has a pair of connection openings, with one connection opening of the door hinge member of one of the hinges providing vertical positioning of the door with respect to the vehicle body and also providing one of either longitudinal or lateral horizontal positioning of the door with respect to the vehicle body, and with another connection opening of the door hinge member of the other associated hinge providing the other of either longitudinal or lateral horizontal positioning of the door with respect to the vehicle body while having vertical tolerance;
a paint station for painting the vehicle body and the door mounted thereon; and
at least one further station for: removing the door from the hinges at the door hinge members thereof with the hinges remaining mounted on the vehicle body, then installing vehicle body components on the painted vehicle body and installing door components on the removed door; and thereafter remounting the door on the hinges at the door hinge members thereof with the previous positioning providing door to vehicle body gap spacing.

10. An assembly line for mounting a vehicle door as in claim 9 further including a vehicle body conveying branch along which the painted vehicle body is conveyed for installation of the vehicle body components, and a door conveying branch along which the painted door is conveyed for installation of the door components.

11. An assembly line for mounting a vehicle door as in claim 9 further including a hinge piercing station for forming the connection openings in the door hinge members of the hinges.

12. An assembly line for mounting a vehicle door as in claim 9 further including a door gauge for determining the proper location of the one connection opening of the door hinge member of the one hinge providing vertical and horizontal positioning of the door, and the door gauge also determining the proper location of the connection opening of the door hinge member of the other hinge providing horizontal positioning of the door.

13. An vehicle door assembly line as in claim 9 wherein the vehicle body gauging station gauges front and rear door openings, and including robots for mounting front and rear sets of upper and lower hinges on the vehicle body and for respectively mounting the front and rear doors on the hinges with door to provide vehicle body gap spacing, door to door gap spacing and door to vehicle body flushness prior to painting and for subsequent door removal for the vehicle body and door component installation and subsequent remounting of the front and rear doors.

14. An assembly line for mounting left and right sets of front and rear vehicle doors on a vehicle body by associated sets of lower and upper door hinges each of which has body and door hinge members pivotally connected to each other, comprising:
apparatus for gauging left and right sets of front and rear door openings of the vehicle body to determine longitudinal and vertical positioning required to provide door to vehicle body gap spacing and door to door;
a robot station for mounting the body hinge members of the hinges on the vehicle body in accordance with the door opening gauge positioning;
at least one robot for mounting left and right front and rear doors on the hinges at the door hinge members each of which has a pair of connection openings, with one connection opening of the door hinge member of one of the hinges providing vertical positioning of the associated door with respect to the vehicle body and also providing one of either longitudinal or lateral horizontal positioning of the door with respect to the vehicle body, and with another connection opening of the door hinge member of the other associated hinge providing the other of either longitudinal or lateral horizontal positioning of the door with respect to the vehicle body while having vertical tolerance;
a paint station for painting the vehicle body and the doors mounted thereon;
a station for removing the doors from the hinges at the door hinge members thereof with the hinges remaining mounted on the vehicle body;
a vehicle body conveying branch for installing vehicle body components on the painted vehicle body;
a pair of left and right door conveying branches for installing door components on the removed left and right painted doors; and
a station for remounting the doors on the hinges at the door hinge members thereof with the previous positioning providing door to vehicle body gap spacing, door to door gap positioning, and door to vehicle body flushness.
